(19) United States
(12) Patent Application Publication
(10) Pub. No.: US 2008/0244856 A1
(43) Pub. Date: Oct. 9, 2008

(54) Drive Device for a Wiper Arm of a Windscreen Wiper Unit

(75) Inventors: Bruno Egner-Walter, Heilbronn (DE); Klaus Epple, Obersulm (DE)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 11/597,775

(22) PCT Filed: May 23, 2005
(86) PCT No.: PCT/EP05/05557

§ 371 Date: Jan. 30, 2008

(30) Foreign Application Priority Data
May 27, 2004 (DE) 10 2004 026 552.6

(51) Int. Cl. B60S 1/34

(52) U.S. Cl. 15/250.21

(57) ABSTRACT

A drive device for a wiper arm of a windscreen-wiper assembly is equipped with a linkage system in a drive train between the wiper arm and a screen-wiper motor. The linkage system comprises at least two intersecting pivot arms, both of which are flexibly connected at one end to a rocker carrying the wiper arm, and one of which is pivot-mounted at its other end on a vehicle-mounted bearing element, and the other is fastened at its other end to a reversibly operable shaft.

The invention relates to a drive device for a wiper arm of a windscreen wiper unit according to the preamble of claim 1.

Drive devices for windscreen wiper assemblies or units are known, in which a linkage system is provided in the drive train between a windscreen wiper motor and a wiper arm or a vehicle-mounted wiper shaft, via which linkage system the movement of a drive train of the windscreen wiper assembly, driven at one end by a crank, is translated into a backwards and forwards rotary motion, i.e. into a reversing motion, of the wiper shaft. This linkage system hereby comprises two pivot arms, each of which is coupled at one end with a rocker and at the other end with the drive train moved by the crank. Permanently connected to the rocker is the wiper shaft, so that the latter and, along with it, the wiper arm, are pivoted about the axis of the wiper shaft.

One of the disadvantages of the known drive devices is the fact that the wiper arm executes a purely pivoting movement about the vehicle-side axis of the wiper shaft, which leads in many cases to an unsatisfactory wiping field being swept by the wiper arm or by a wiper blade present there. One of the reasons in particular why this applies is that, for design reasons, vehicle windows, especially including rear vehicle windows, are nowadays frequently configured with a small height dimension and a relatively great width, or, conversely, with a relatively great height in relation to the window width, so a pivoting motion of the wiper arm about the central axis of the wiper shaft purely in the shape of the arc of a circle leads to this unsatisfactory wiping field, in which a not inconsiderable proportion of the vehicle screen is not swept at all by the wiper arm or wiper blade.

It is the object of the invention to indicate a drive device with which, along with the opportunity of low-cost production and a robust, operationally-reliable design, an enlargement and adaptation or optimisation of the shape of the wiping field covered by the moved wiper arm or the wiper blade present there is achieved. A drive device according to claim 1 is developed to achieve this object.

Owing to the design according to the invention, the wiper arm is pivoted, during operation of the windscreen wiper assembly, about the central axis of its fastening to the rocker constituting part of the linkage system, and simultaneously the central axis of the fastening of the wiper arm is moved along a path. The shape of the path on which the central axis of the wiper-arm fastening is moved can be influenced, in particular, by the geometry and/or the orientation or arrangement of the linkage system, in such a way that an optimum wiping field is achieved for the particular application, in other words a wiping field enlarged in width in the case of especially wide vehicle screens, for example.

The drive device according to the invention is especially suitable for rear windows of vehicles, but may also be used in other screen wiper assemblies. Developments of the invention are the subject-matter of the dependent claims.

The invention is explained in greater detail below with reference to example embodiments in the Figures. They show:

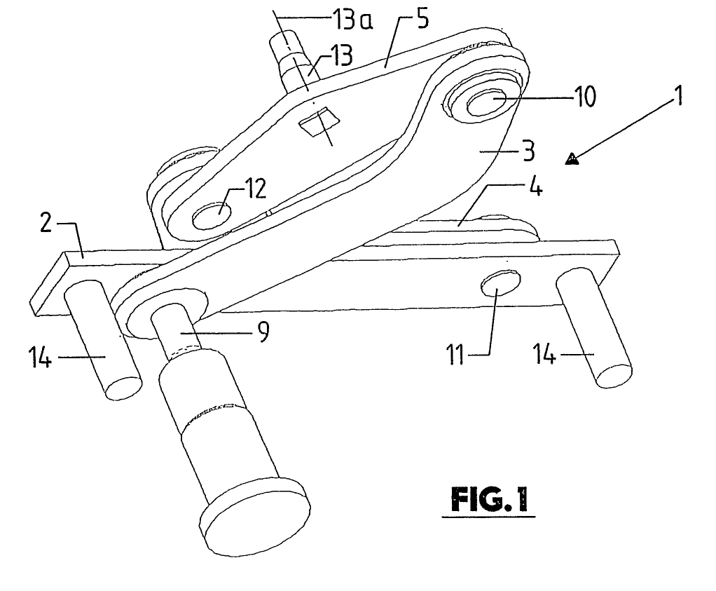

FIG. 1 in a perspective view, one embodiment of the linkage system according to the invention for use in a screen wiper assembly for a vehicle, in particular in a rear-window wiper assembly;

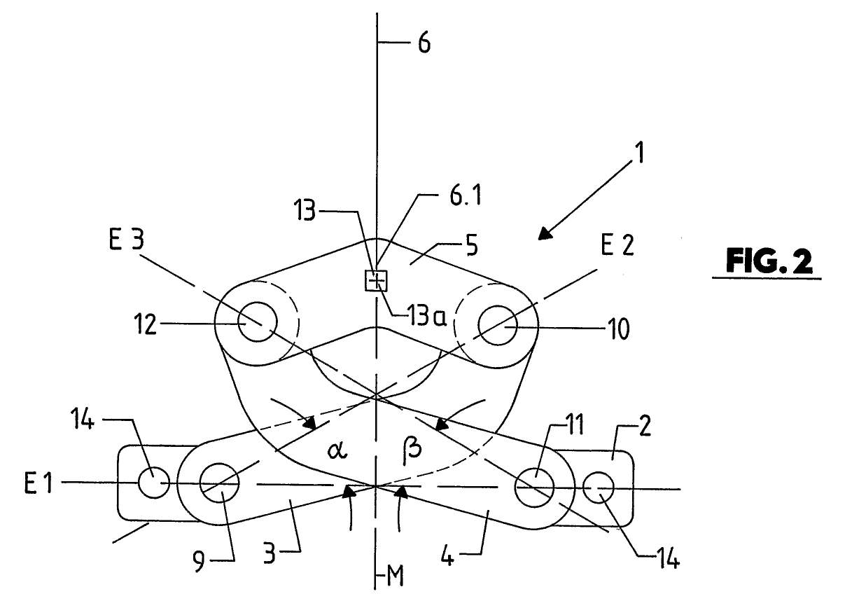

FIG. 2 in a simplified view, the linkage system in a central position with indicated wiper arm for the unshown wiper blade of the screen wiper assembly;

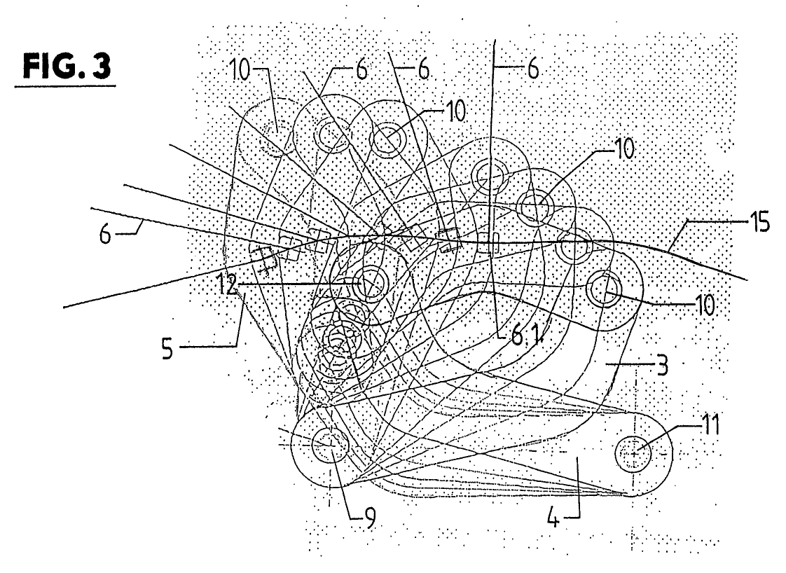

FIG. 3 the position of the pivot arms of the linkage system and the wiper arm, and the trajectory of the mounting for the wiper arm in different rotary positions of the wiper shaft;

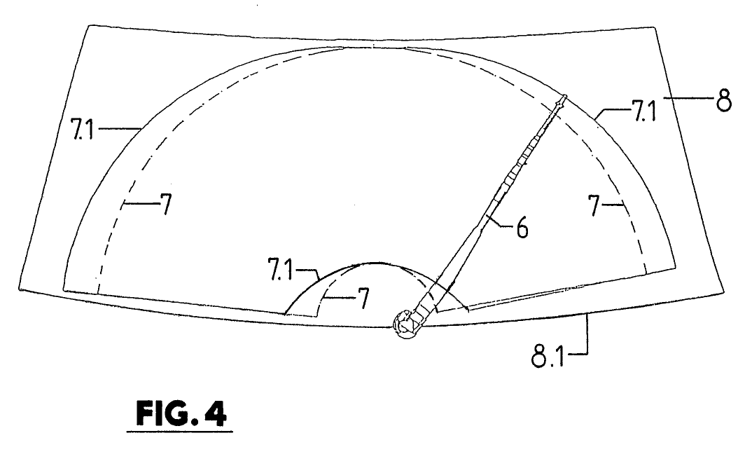

FIG. 4 in a schematic view, the wiping field swept by the wiper arm or wiper blade;

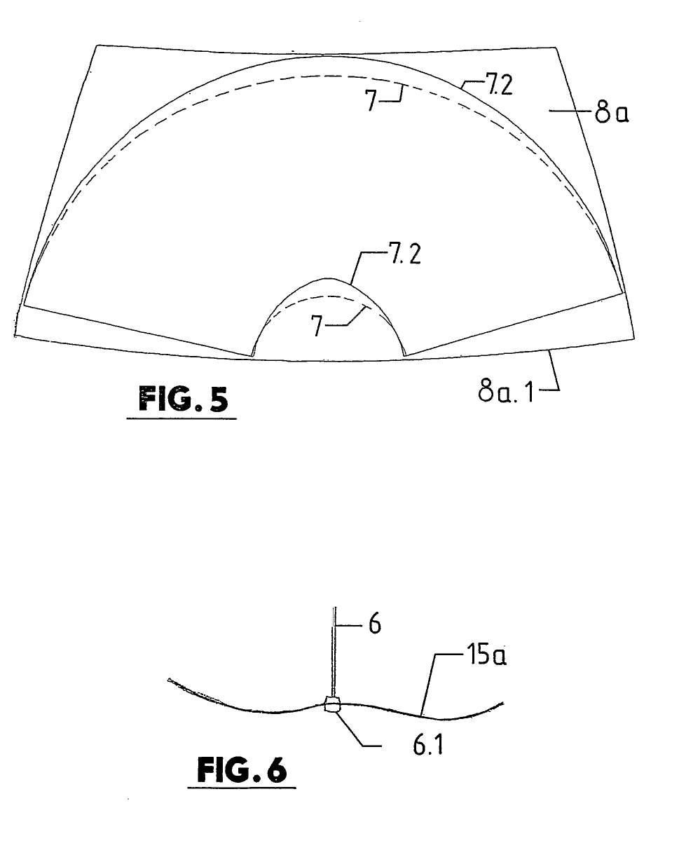

FIG. 5 a view similar to FIG. 4, but with installation of the linkage system turned through 180°;

FIG. 6 the trajectory of the mounting for the wiper arm, with the installation of the linkage system turned through 180° as in FIG. 5.

In the Figures, 1 is a linkage system, which essentially consists of a mounting plate or bearing element 2, which is oblong-shaped in the embodiment shown, of two pivot arms 3 and 4, and of a rocker 5, to which the wiper arm 6 is fastened with rotational resistance with its end 6.1.

In the embodiment shown in FIGS. 1-4, the linkage system 1 serves, when the windscreen wiper assembly is activated, to enlarge in its lateral regions the wiping field on the vehicle screen 8 which is swept by the wiper arm 6 or by the wiper blade fastened on this wiper arm and which extends between the lines 7.1, in order to achieve the widest possible wiping field for a flat vehicle screen or rear window 8 in comparison with a wiping field extending between the broken lines 7, as conventionally produced by a purely pivoting motion of the wiper arm about a fixed central axis.

In detail, the linkage system 1 is designed in such a manner that the pivot arm 3 is connected at one of its ends to the shaft 9 of a reversing electromotive drive or windscreen wiper motor, which is otherwise not further shown. The other end of the pivot arm 3 is connected via an articulation 10 to one end of the rocker 5. The pivot arm 4 is coupled at one end with the bearing element 2 via an articulation 11 and connected at its other end to the other end of the rocker 5 via an articulation 12. Provided between the two articulations 10 and 12 is a fastening or retaining element 13, which in the embodiment shown takes the form of a peg anchored with rotational resistance to the rocker 5, to which the wiper arm 6 is then fastened with rotational resistance at its end 6.1, e.g. in the same manner as occurs in the case of conventional fastening to a wiper shaft.

The axes of the articulations 10-12 and the axis of the shaft 9 as well as the axis of the retaining element 13 are parallel with one another and, in the installed state, are orientated normal to or roughly normal to the plane of the vehicle screen 8. The configuration is further arranged in such a manner that, in the central position of the wiper arm 6 and the linkage system 1 as shown in FIG. 2, the axes of the shaft 9 and of the articulation 11 are arranged in a common plane E1, running normal to the plane of projection of FIG. 2, in which plane the longitudinal axis of the bearing element 2 also lies in the case of the embodiment shown.

Furthermore, the axes of the shaft 9 and of the articulation 10 are arranged in a common plane E2 running normal to the plane of projection of FIG. 2, which, in this central position, encloses with plane E1 an angle α smaller than 9°, which opens out towards the articulation 11. The axes of the articulations 11 and 12 lie in a common plane E3 running normal to the plane of projection of FIG. 2, which, in this central position, encloses with plane E1 an angle β, which opens out towards the shaft 9 and, in the embodiment shown, is equal to angle α in the central position. Further, the fastening element 13 is provided on the rocker 5 in a manner such that, in the central position of the linkage system 1, this fastening element is located on the side of a connecting line between articulations 10 and 12 that faces away from the bearing element 2, and the fastening element 13 exhibits the same centre distances from both of the articulations 10 and 12 and thereby defines with these articulations a shallow isosceles triangle. As can be seen, the components of the linkage system 1 are arranged in a plurality of planes in a manner such that these components do not mutually obstruct one another during movement. The connecting line between the articulations 10 and 1 2 lies in the central position parallel with plane E1.

Articulations 10 and 12 as well as the fastening element 13 are, in the central position, located on a common side of plane E1, wherein articulations 10 and 12 exhibit the same, smaller distance, and the fastening element 13 a somewhat greater distance from plane E1. Furthermore, in the central position relative to the arrangement of the articulation and pivoting axes, the linkage system 1 is in mirror symmetry to a central plane M, which is arranged parallel with these axes and encloses the longitudinal dimension of the wiper arm 6.

In the embodiment shown, the linkage system 1 is defined geometrically by the following dimensions:

| Centre distance between shaft 9 and articulation 11 | 58 units |
|---|---|
| Effective length of pivot arm 3 or centre distance | 55 units |
| between shaft 9 and articulation 10 | |
| Effective length of pivot arm 4 or centre distance | 55 units |
| between articulations 11 and 12 | |
| Centre distance between articulations 10 and 12 | 36 units |
| Centre distance between articulations 10 or 12 and the | 8 units |
| fastening element 13 | |
| Angle α in the central position | 37° |
| Angle β in the central position | 37° |

wherein a unit is, for example, 1 mm.

To generate the laterally enlarged wiping field extending between the lines 7.1 (FIG. 4), the linkage system 1 is mounted, with the bearing element 2 together with the electromotive drive which can be used to reverse the shaft 9, on the vehicle, or on its bodywork, below the lower, horizontal boundary 8.1 of the vehicle screen, using fastening elements or bolts 14, in a manner such that the connecting line between the shaft 9 and the articulation 11 is orientated to be parallel or roughly parallel with the boundary 8.1 and the rocker 5 is located on this side of the connecting line facing towards the vehicle screen 8. The wiper arm 6 is fastened on the rocker 5 in a manner such that, starting from the fastening element 13, it extends normal or roughly normal to the connecting line between the articulations 10 and 12, as indicated in FIG. 2. Starting from this central position, the pivot arm 3 can be pivoted, by means of the reversing drive, about the axis of the shaft 9, this taking place in the form of an enlargement and a reduction of the angle α, wherein one of the two end positions preferably constitutes the parked position and the other end position constitutes the reversal position.

With the electromotive drive switched on, the pivot arm 3 is reversibly pivoted about the axis of the shaft 9, as a result of which, as shown in FIG. 3, the central axis 13a of the fastening element 13, and thereby the end 6.1 of the wiper arm 6, then move along the trajectory indicated in this Figure by line 15, this taking place with simultaneous pivoting of the wiper arm 6 about the non-stationary central axis 13a. The movement of the wiper arm 6 thus comprises a translatory motion running roughly parallel with the lower boundary 8.1 of the vehicle screen 8 and a pivoting movement about the central axis 13a.

The situation of the wiper arm 6 and the positions of the articulations 10 and 12 for the pivoting of the linkage system 1 out of the central position in one direction are also indicated in FIG. 3.

FIG. 5 shows, in a view similar to that of FIG. 4, a different wiping field achievable with the linkage system 1 according to the invention, extending between the lines 7.2, which is suitable for a narrower but taller vehicle screen 8i a. In this embodiment, the linkage system 1 is installed reversed, i.e. in a manner such that, in the central position of the system, the articulations 10 and 12 and the fastening element 13 are located on the side of the connecting line between the axes of the shaft 9 and the articulation 11 facing away from the lower boundary 8a.1 of the vehicle screen 8a. The wiper arm 6 is hereby fastened to the rocker 5 in a manner such that, with its longitudinal dimension, it intersects the connecting line of the articulations 10 and 12 normal or roughly normal thereto, and also the connecting lines between the shaft 9 and the articulations 10 or 11. The end 6.1 of the wiper arm 6 and/or the central axis 13a of the wiper-arm fastening thus moves along the line 15a shown in FIG. 6, so that, owing to the combination of a pivoting motion of the wiper arm 6 about the central axis 13a and a to some extent translatory motion of this central axis 13a along a path 15a, an enlargement of the wiping field extending between the lines 7.2 in the upper region relative to a wiping field extending between the broken lines 7a occurs, this being achievable by means of a pivoting motion purely in the shape of the arc of a circle.

The invention has been described above with reference to example embodiments. Numerous modifications and alterations are of course possible without the inventive concept on which the invention is based being abandoned.

For example, it is possible for the bearing element 2 to be of a design other than oblong-shaped. It is furthermore possible for the bearing element 2 to be provided directly on the electromotive drive and/or for the articulation 11 to be arranged on a housing of this drive. The shaft 9 is, for example, the output shaft of a reversing windscreen-wiper motor or geared motor, but may also be a shaft mounted on the vehicle, which is reversibly driven by, for example, a crank drive.

### LIST OF REFERENCE NUMBERS

1 Linkage system
2 Bearing element
3, 4 Pivot arm
5 Rocker
6 Wiper arm
6.1 End of wiper arm
7, 7a Broken line
7.1, 7.2 Line
8, 8a Vehicle screen
8.1, 8a.1 Lower boundary of vehicle screen 8/8a
9 Shaft
10, 11, 12 Articulation
13 Fastening element
13a Central axis
14 Fastening bolt
15, 15a Line
E1, E2, E3 Plane
M Central plane
α Angle between E1 and E2
β Angle between E1 and E3

1. Drive device for a wiper arm of a windscreen wiper unit, with a cross linkage system in a drive train between the wiper arm and a screen-wiper motor, wherein the cross linkage system comprises at least two intersecting pivot arms, of which a first pivot arm is flexibly connected at one end, via a first articulations, to a rocker, and at its other end is able to pivot about a first pivot axis, and of which a second pivot arm is coupled at one end, via a second articulation, to the rocker at a distance from the first articulation and at its other end is able to pivot about a second pivot axis formed by a third articulation, wherein the first and second pivot axes exhibit a fixed, i.e. non-varying during the operation of the drive device, mutual centre distance, and wherein the wiper arm is connected to the rocker with rotational resistance, characterised in that the first pivot axis takes the form of a vehicle-mounted shaft, which is reversibly operable by the screen-wiper motor and which is operationally connected to the first pivot arm, and that the articulation constituting the second pivot axis is a vehicle-mounted articulation.

2. Drive device as claimed in claim 1, characterised in that the articulation constituting the second pivot axis is provided on a bearing mountable on the vehicle or takes the form of a bearing mountable on the vehicle.

3. Drive device as claimed in claim 1, characterised in that the articulation constituting the second pivot axis is provided on a housing or bearing of the screen-wiper motor.

4. Drive device as claimed in claim 1, characterised in that the reversibly operable shaft is the output shaft of the screen-wiper motor or of a gear of the screen-wiper motor.

5. Drive device as claimed in claim 1, characterised in that the shaft constituting the first pivot axis is mounted in a vehicle-mounted bearing and is operationally connected to the screen-wiper motor via a crank drive.

6. Drive device as claimed in claim 1, characterised in that, in a position of the wiper arm between the end positions of the wiper-arm movement, the first and second articulations are arranged on a side of a connecting line between the first and second pivot axes facing towards the vehicle screen.

7. Drive device as claimed in claim 1, characterised in that, in a position of the wiper arm between the end positions of the wiper-arm movement, the first and second articulations are arranged on a side of a connecting line between the first and second pivot axes facing away from the vehicle screen.

8. Drive device as claimed in claim 2, characterised in that the articulation constituting the second pivot axis is provided on a housing or bearing of the screen-wiper motor.

9. Drive device as claimed in claim 2, characterised in that the reversibly operable shaft is the output shaft of the screen-wiper motor or of a gear of the screen-wiper motor.

10. Drive device as claimed in claim 3, characterised in that the reversibly operable shaft is the output shaft of the screen-wiper motor or of a gear of the screen-wiper motor.

11. Drive device as claimed in claim 2, characterised in that the shaft constituting the first pivot axis is mounted in a vehicle-mounted bearing and is operationally connected to the screen-wiper motor via a crank drive.

12. Drive device as claimed in claim 3, characterised in that the shaft constituting the first pivot axis is mounted in a vehicle-mounted bearing and is operationally connected to the screen-wiper motor via a crank drive.

13. Drive device as claimed in claim 1, characterised in that, in a position of the wiper arm between the end positions of the wiper-arm movement, the first and second articulations are arranged on a side of a connecting line between the first and second pivot axes facing towards the vehicle screen.

14. Drive device as claimed in claim 3, characterised in that, in a position of the wiper arm between the end positions of the wiper-arm movement, the first and second articulations are arranged on a side of a connecting line between the first and second pivot axes facing towards the vehicle screen.

15. Drive device as claimed in claim 4, characterised in that, in a position of the wiper arm between the end positions of the wiper-arm movement, the first and second articulations are arranged on a side of a connecting line between the first and second pivot axes facing towards the vehicle screen.

16. Drive device as claimed in claim 5, characterised in that, in a position of the wiper arm between the end positions of the wiper-arm movement, the first and second articulations are arranged on a side of a connecting line between the first and second pivot axes facing towards the vehicle screen.

17. Drive device as claimed in claim 2, characterised in that, in a position of the wiper arm between the end positions of the wiper-arm movement, the first and second articulations are arranged on a side of a connecting line between the first and second pivot axes facing away from the vehicle screen.

18. Drive device as claimed in claim 3, characterised in that, in a position of the wiper arm between the end positions of the wiper-arm movement, the first and second articulations are arranged on a side of a connecting line between the first and second pivot axes facing away from the vehicle screen.

19. Drive device as claimed in claim 4, characterised in that, in a position of the wiper arm between the end positions of the wiper-arm movement, the first and second articulations are arranged on a side of a connecting line between the first and second pivot axes facing away from the vehicle screen.

20. Drive device as claimed in claim 5, characterised in that, in a position of the wiper arm between the end positions of the wiper-arm movement, the first and second articulations are arranged on a side of a connecting line between the first and second pivot axes facing away from the vehicle screen.
